(19) United States
(12) Patent Application Publication
(10) Pub. No.: US 2015/0000709 A1
(43) Pub. Date: Jan. 1, 2015

(54) SYSTEM FOR HEATING PROCESS SOLUTIONS FOR PRELIMINARY TREATMENT OF A SURFACE BEFORE COATING

(71) Applicant: TKS Industrial Company, Troy, MI (US)

(72) Inventor: Alexandre Ducasse, West Bloomfield, MI (US)

(21) Appl. No.: 13/930,123

(22) Filed: Jun. 28, 2013

(51) Int. Cl. B08B 3/08

(52) U.S. Cl. CPC B08B 3/08
USPC 134/29; 134/84

(57) ABSTRACT

A system for preliminary treatment of a surface to prepare the surface for application of a coating includes a plurality of process tanks, each of which contains a heated liquid into which the surface is immersed to prepare it for coating, and a dedicated hot water generator associated with each of the plurality of process tanks. Each dedicated hot water tank directly or indirectly heats only the liquid contained in the associated process tank, eliminating hot water distribution and return piping, heat exchangers, and control valves used in conventional systems.

### CROSS-REFERENCE TO RELATED APPLICATIONS

Not applicable.

### FIELD OF THE DISCLOSURE

This disclosure relates to process equipment for preparing a metal surface for applications of a coating, and more particular to hot water generators used for washing, degreasing and conditioning a metal surface before application of a coating.

### BACKGROUND OF THE DISCLOSURE

In order to improve integrity, appearance, functionality and durability of a coating (e.g., a paint) on a metal surface it is generally recognized in the art that the metal surface must be cleaned, degreased and conditioned prior to application of the coating. Such treatments remove contaminants that interfere with good adhesion between the metal surface and the coating, can improve corrosion resistance, and can promote enhanced adhesion between the metal surface and the coating.

FIG. 1 is a schematic diagram of typical process equipment that has been used for preliminary treatment of a part or workpiece having a metal surface prior to application of a coating to the metal surface. The process equipment includes a plurality of treatment tanks containing a liquid for cleaning, degreasing or otherwise treating a surface of a part by spraying the surface with the liquid or dipping (immersing) the surface in the liquid. The illustrated equipment includes a preliminary wash tank 20, a degreasing tank 22, and a phosphate treatment tank 24. The liquids in the process tanks 20, 22 and 24 can be agitated and/or the parts can be moved through the liquids to provide forced convection and enhanced mass transfer between the liquids and metal surface. The preliminary wash tank 20, which may contain an aqueous detergent solution, can be used to remove dirt, debris and particulate materials from the metal surface. The degreasing tank 22, which may contain a detergent solution, a soap solution, or an organic solvent such as acetone or a halogenated solvent such as trichloroethylene, perchloroethylene or n-propyl bromide, can be used for dissolving oils and/or other organic materials that can be deposited onto metal surfaces of a workpiece during metal working operations such as cold rolling, stamping, drawing, bending, machining, cutting, welding, etc. The phosphate treatment tank, which may contain a phosphate solution such as a zinc phosphate solution, can be used to improve corrosion resistance and/or to improve adhesion with a subsequently applied coating.

The liquids used in process tanks 20, 22 and 24 must generally be heated to provide adequate cleaning, degreasing and conditioning of the metal surfaces that are to be coated. In the conventional equipment arrangement, hot water supplied from one or more hot water generators 30, 32 is circulated through one side of heat exchangers 40, 42 and 44, while the liquids from the tanks 20, 22 and 24 are circulated through the other sides of heat exchangers 40, 42 and 44, respectively, and back into the tanks 20, 22, 24. In other words, conventional systems for preliminary treatment of a metal surface to prepare it for coating application have employed a central hot water generator or hot water generator system comprising a series of hot water generators, and have required the associated distribution piping 50 and return piping 52, an individual heat exchanger for each tank, and various control valves 60, 62, 64.

### SUMMARY OF THE DISCLOSURE

Disclosed herein is a system (or an arrangement of process equipment) for preparing a surface for application of a coating, which includes a plurality of process tanks, each of which contains a heated liquid contacted with or applied to the surface, such as by spraying the surface with the liquid or immersing the surface in the liquid, and a dedicated hot water generator associated with each of the plurality of process tanks. Each hot water generator either directly heats only the liquid contained in the associated process tank, or indirectly heats only the liquid contained in the associated process tank via a heat exchanger.

Also disclosed is an arrangement of process equipment for preparing a surface for application of a coating comprising at least one process tank for containing a process liquid that is contacted with the surface or applied to the surface, a dedicated hot water generator for heating the process liquid, conduit for conveying process liquid directly from the process tank to an inlet port of the dedicated hot water generator, and conduit for conveying heated process liquid from an outlet port of the dedicated hot water generator directly to the process tank. This arrangement eliminates the heat exchanger that is used in conventional process equipment arrangements for preparing a surface for application of a coating, reducing equipment costs, maintenance costs, and required floor space, while also providing enhanced energy efficiency, all of which contribute to a substantial reduction in production costs.

Also disclosed is a process for preparing a surface for application of a coating by applying a heated process liquid from each of the process tanks of the system to the surface.

### BRIEF DESCRIPTION OF THE DRAWINGS

FIG. 1 is a schematic diagram of a conventional system for preliminary treatment of a metal surface to prepare the surface for application of a coating.

FIG. 2 is a schematic diagram of a new system for preliminary treatment of a metal surface to prepare the surface for application of a coating, which is illustrative of the novel concepts disclosed herein.

### DETAILED DESCRIPTION OF THE ILLUSTRATED EMBODIMENTS

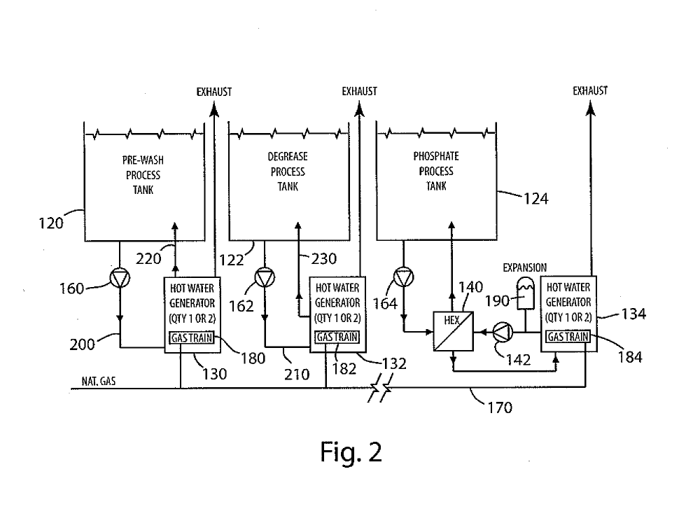

An illustrative system for preparing a metal surface for application of a coating is shown in FIG. 2. Although the illustrative system includes three process tanks 120, 122 and 124 containing a liquid that is heated with a hot water generator, fewer (e.g., one or two) or more than three tanks for containing a liquid heated by a hot water generator can be employed. Additionally, the schematic diagram of FIG. 2 is not intended to infer that the metal surfaces are not subjected, to intervening treatment steps between immersion in the tanks 120, 122, 124. To the contrary, it is contemplated that the parts or workpieces having a metal surface that is being prepared for application of a coating will typically be rinsed with water between a preliminary wash to remove dirt, debris, etc. and a degreasing step, and again between the degreasing step and a phosphate treatment step. Additionally, while the illustrated embodiments are described as being useful for treating metal surfaces, it will be appreciated that the processes and process equipment arrangements can be used for immersing non-metal (e.g., plastic) surfaces into a process liquid that cleans or otherwise conditions the non-metal surface for application of a coating.

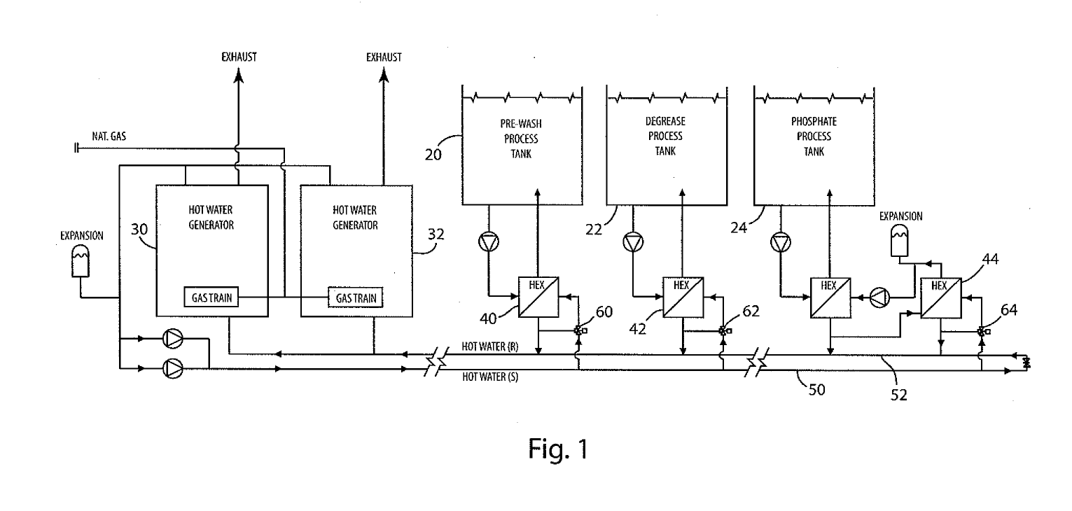

The new systems disclosed herein differ from the conventional systems, an example of which is illustrated in FIG. 1, by having a dedicated hot water generator associated with each of a plurality of process tanks, rather than a common or central hot water generator or hot water generator system in which distribution piping 50 is required to distribute heated water to each of a plurality of heat exchangers, and return piping 52 is required to collect and return water to the hot water generator. A “dedicated hot water generator” refers to a hot water generator that is piped to, associated with, and heats the liquid in a single process tank, eliminating the need for the distribution piping 50 and return piping 52, as well as eliminating the need for heat exchangers for certain process tanks, such as those containing an aqueous liquid (i.e., a liquid comprised of water as solvent and other minor components dissolved in the water). The new systems disclosed herein can also eliminate the need for control valves, such as valves 60, 62 and 64 of the conventional system shown in FIG. 1.

By eliminating process equipment (e.g., heat exchangers), piping, and control valves, more compact systems, requiring less floor space can be designed. Additionally, the smaller dedicated hot water generators 130, 132, 134 can be located in closer proximity to the process tanks 120, 122, 124 that each serves. This reduces the total length of the piping needed to convey the heated water, which in turn results in less loss of radiated energy from the pipe and thus provides energy and cost savings. The ability to use a smaller hot water generator in close proximity to the associated process tank also facilitates modular designs in which each process tank and its associated hot water generator can be mounted on single platform or skid to facilitate reconfiguration of the system at a lower cost and in less time than would be needed with a conventional system, such as that described in the Background of the Disclosure and shown in FIG. 1.

By conveying process liquids from tanks 120 and 122 directly to inlet ports of hot water generators 130 and 132, respectively, via conduits 200 and 210, respectively, and conveying the heated water directly from outlet ports of the hot water generators 130 and 132 via conduits 220 and 230, respectively, the need for a heat exchanger to transfer heat from water that has been heated in a hot water generator (or boiler) to the process liquid is eliminated. Elimination of the heat exchanger by directly heating the process liquid in a hot water generator also eliminates heat losses at the heat exchanger and the associated piping between the heat exchanger and the hot water generator, and facilitates selection of a lower outlet temperature from the hot water generator. For example, a conventional arrangement using a heat exchanger may require an outlet temperature of about 180° F. (about 85° C.), whereas a similar arrangement in which the process liquid is heated directly by a hot water generator may require a lower temperature, such as about 120° F. to 130° F. (about 50° C. to 55° C.). As a result, it then becomes possible to employ a condensing boiler typically having an efficiency greater than 90% or greater than 95%, providing a highly energy efficient process. Condensing boilers are commercially available and are designed to use waste heat in the flue gases to pre-heat the lower temperature liquid entering the boiler (or hot water generator).

In certain cases it may not be practical to use a hot water generator to directly heat a process liquid. For example, in the case of a phosphate process liquid (e.g., for tank 124), it may be desirable to employ a heat exchanger (e.g., 140) to avoid the risk of crystallization and/or precipitation of a phosphate salt in the hot water generator. Other examples in which it may be more desirable to employ a heat exchanger rather than directly heating the process liquid in a hot water generator include extremely caustic or otherwise corrosive process liquids, and other process liquids that could present a risk of plugging or fouling a hot water generator.

While the systems described herein employ a preliminary wash tank 120, a degreasing tank 122 and a phosphate treatment tank 124, which are typically used for preparing iron-containing metals (e.g., steels) for application of a coating, the systems can be used or be adapted for use in preparing other types of metals for application of a coating, and may include other types of pretreatments or any number of pretreatments involving contacting the surface to be coated with process liquids from a series of heated liquid baths.

The subsequent coating processes and materials do not form a novel aspect of any invention disclosed herein and may involve generally any application technique including spraying, roll-to-roll coating techniques, electrochemical techniques, chemical vapor deposition, physical vapor deposition, etc., and generally any aesthetic and/or functional coating that can be applied to a treated metal surface.

Pumps 160, 162 and 164 can be used for conveying liquid from tanks 120, 122 and 124, respectively, through hot water generators 130, 132 and heat exchanger 140, respectively, and then back into the respective tanks.

As an alternative to passing the liquids from the process tanks directly through a dedicated hot water generator, pump 164 conveys liquid from process tank 124 through a first side of a heat exchanger, with a second pump 142 pumping hot water from hot water generator 134 through the second side of heat exchanger 140. This arrangement still has the advantage of reducing the need for control valves, distribution piping from a central hot water generator, return piping to the central hot water generator, and therefore still provides lower installation costs, modularity, reduced need for floor space, and energy and cost savings.

In the illustrated embodiments, natural gas is distributed to hot water generators 130, 132, 134 through piping 170 to gas trains (burners) 180, 182, 184. However, other types of fuels (e.g., heating oil, kerosene, etc.) can be used as an alternative. It is also conceivable that electric heaters could be used.

The heat exchanger(s) used in the systems described herein (e.g., heat exchanger 140) can generally be selected from various designs that facilitate heat transfer from one fluid to another without direct contact between the fluids (e.g., a plate-type heat exchanger).

In the illustrated embodiments of FIG. 2, tank 120 contains a preliminary wash solution for facilitating removal of dirt, debris, particles, etc. from the metal surface that is being prepared for application of a coating. The preliminary wash solution can comprise an aqueous (water-based) composition containing a detergent (e.g., sulfated or sulfonated surfactant) and/or soap (e.g., a metallic salt of a fatty acid, such as sodium lauryl sulfate). Tank 122 contains a degreasing agent, which can be an organic solvent or solvent system or an aqueous composition comprising one or more surfactants, such as a soap or detergent, for removing oil and any other organic materials that may have been deposited on the metal surface that is being prepared for application of a coating. Such oils and other organic materials can be deposited on metal workpieces during various cutting, milling, bending and other machining or shaping operations. Examples of organic solvents that may be employed in a degreasing composition include acetone, and various halogenated compounds such as trichloroethylene, perchloroethylene and n-propyl bromide.

An expansion chamber 190 can be provided in the fluid conduit path for conveying heated water from hot water generator 134 to heat exchanger 140 in order to compensate for specific volume changes of the hot water attributable to temperature fluctuations.

What is claimed is:

1. An arrangement of process equipment for heating solutions for treatment of a surface before application of a coating, comprising:
a plurality of process tanks used for preparing a surface for application of a coating, each for containing a heated liquid for treating the surface; and
a dedicated hot water generator associated with each of the plurality of process tanks.

2. The arrangement of claim 1, including at least three process tanks that each contain a heated liquid.

3. The arrangement of claim 1, in which at least one of the process tanks contains an aqueous soap or detergent composition.

4. The arrangement of claim 1, in which at least one of the process tanks contains a degreasing agent.

5. The arrangement of claim 1, in which at least one of the process tanks contains a phosphate dissolved in water.

6. The arrangement of claim 1, in which at least one of the process tanks has an associated heat exchanger and piping to facilitate heat transfer from the dedicated hot water generator associated with the at least one process tank having an associated heat exchanger to liquid circulated from the at least one process tank, through the associated heat exchanger and back to the at least one process tank.

7. The arrangement of claim 1, including at least one preliminary wash tank containing an aqueous soap or detergent composition, at least one degreasing tank containing a degreasing agent, and at least one phosphate treatment tank containing a metal phosphate dissolved in water.

8. A process of preparing a metal surface for application of a coating, comprising:
immersing the metal surface in each of the plurality of process tanks of the arrangement of claim 1.

9. An arrangement of process equipment for heating a solution for treatment of a surface to prepare the surface for application of a coating, comprising:
a tank for containing a process liquid for treating the surface;
a dedicated hot water generator for heating the process liquid;
conduit for conveying the process liquid directly from the tank to an inlet port of the dedicated hot water generator; and
conduit for conveying heated process liquid from an outlet port of the dedicated hot water generator directly to the tank.

10. The arrangement of claim 9, in which the tank contains an aqueous soap or detergent composition.

11. The arrangement of claim 9, in which the tank contains a degreasing agent.

12. The arrangement of claim 9, in which the tank contains a phosphate dissolved in water.

13. The arrangement of claim 9, in which the hot water generator is a condensing boiler.
